(19) United States
(12) Patent Application Publication
(10) Pub. No.: US 2018/0346771 A1
(43) Pub. Date: Dec. 6, 2018

(54) COMPOSITE COATING AND METHOD OF MANUFACTURE AND APPLICATION FOR CORROSION PROTECTION OF STEEL SUCKER RODS

(71) Applicant: Lifting Solutions Inc., Edmonton (CA)

(72) Inventor: ROB SJOSTEDT, Foothill Ranch, CA (US)

(21) Appl. No.: 15/993,753

(22) Filed: May 31, 2018

Related U.S. Application Data
(60) Provisional application No. 62/513,234, filed on May 31, 2017.

(51) Int. Cl. C09J 163/00; E21B 17/00; C09J 9/00

(52) U.S. Cl. CPC C09J 163/00; E21B 43/126; C09J 9/00; E21B 17/00

(57) ABSTRACT

This disclosure discloses that a composite material, and its method of manufacture, can be provided where the composite material includes a synthetic fiber veil and a thermosetting polymer adhesive as a corrosion protection coating for steel sucker rods, pony rods and continuous sucker rods.

### CROSS-REFERENCE TO RELATED APPLICATIONS

This application claims priority of U.S. provisional patent application Ser. No. 62/513,234 filed May 31, 2017, which is incorporated by reference into this application in its entirety.

### TECHNICAL FIELD

This disclosure is related to a field of sucker rod engineering, design and manufacturing, in particular, composite corrosion coating of steel sucker rods for use in down-hole reciprocating rod pump and rotary progressive cavity pump artificial lift.

### BACKGROUND

Sucker rods for use with rod pumps and progressive cavity pumps are traditionally made from individual lengths of steel rod sections that are connected together by threaded couplings. The individual sucker rods are normally 25 feet or 30 feet in length and are connected together to form a sucker rod string that is run down-hole. A typical sucker rod string is from 1500 to 10,000 feet in length although shorter and longer strings are occasionally used. Sucker rods can also be in the form of a continuous length of steel rod that is coiled for transport and uncoiled as it is inserted down-hole. The sucker rod string connects the reciprocating surface pumping unit to the down-hole rod pump or rotational surface drive head to the down-hole progressive cavity pump.

Steel sucker rods in certain downhole environments are subject to corrosion that can lead to deterioration of the steel material and associated failure in operation. Since the sucker rod in pumping applications is subjected to fatigue loading, corrosion can accelerate the progression of fatigue damage and significantly reduce the time until rod failure. This results in production downtime along with cost to bring a work-over rig in and labor to pull and replace the rod string.

Most of the corrosion common to sucker rods is attributable to the presence of water in varying amounts in the production fluid. Corrosion in the presence of water is an electrochemical process. Sucker rods also experience chemical corrosion due to the presence of hydrogen sulfide. When both hydrogen sulfide and water are present in well fluids, sulfuric acid is formed leading to the formation of iron sulfide. Iron sulfide accelerates the corrosion process and causes deep pitting in the steel sucker rods. Severe corrosion pitting of steel sucker rods is also caused by carbon dioxide and water forming carbonic acid.

Numerous approaches to protecting sucker rods from corrosion have been used over time with varying degrees of effectiveness and associated cost. Common approaches include flame spraying non-corroding metals onto the steel sucker rod or spraying epoxy resin onto the sucker rods including combinations of spray metal and epoxy coatings. The lack of broad usage of traditional coated sucker rods is indication that the solutions are not as effective in terms of performance and cost as the industry would like. Traditional sucker rod coatings and application methods can double (or more) the cost of the sucker rod. Apart from additional processing, a significant contributor to cost is material waste due to spraying the coating onto the sucker rod. Overspray loss can be as high as 50% of the material applied to the rod. The rod must be rotated to be sprayed or the spray gun must be rotate around the rod which is added complexity. The coating materials are expensive so material waste is a significant problem.

Coatings for steel sucker rods can be subject to damage before they are even put into the well. Normal transportation and handling of the steel sucker rod can result in damage to whatever coating is applied. If damaged, water and well fluids can “wick” underneath some coatings in the damaged area and cause corrosion underneath the coating. Thermoplastic polymer coatings are particularly susceptible to wicking of well fluids and corrosion of the rod underneath the coating since they typically do not adhere to the steel rod.

Sucker Rods are also commonly stored outside for extended periods of time where polymer coatings are subject to ultraviolet light deterioration.

Once, installed in the well the sucker rod is exposed to well fluids with conditions varying along the well length due to changes in temperature and pressure which in turn influence the fluid composition particularly as it relates to gas. Conventional steel sucker rods are also subject to wear and “rod slap” against the production tubing with the magnitude depending on the wellbore geometric profile, down-hole equipment configuration and the pumping conditions. Standard sucker rods primarily contact the tubing at the couplings and accordingly wear primarily at the couplings but continuous steel sucker rods due to their constant diameter, contact more uniformly along their length. Consequently, continuous sucker rods can require thicker or more wear resistant coatings than the typically non-contacting body of standard sucker rods. Coatings can also be beneficial at the pin ends of continuous steel sucker rods.

As oil wells are drilled deeper and deeper, the need for higher strength steel alloy sucker rods is greater. High strength steel alloys are more subject to corrosion deterioration so the need for improved sucker rod coatings is greater.

Another important consideration for coatings on steel sucker rods is the hardness of the coating and potential of wear induced by the coated sucker rod on the production tubing. The tubing is more expensive than the sucker rods, as well as more costly to pull and replace, so one would not want the sucker rods to unduly wear the tubing.

It is, therefore, desirable to provide a coating for steel sucker rods that overcomes the shortcomings of traditional sucker rod coatings.

### SUMMARY

In some embodiments, a composite material can be provided comprised of a synthetic fiber veil impregnated with a thermosetting polymer adhesive for corrosion coating of steel sucker rods and continuous steel sucker rods. An associated method of manufacture is also provided.

In some embodiments, a composite material can be comprised of a synthetic polyester veil and epoxy adhesive for coating steel sucker rods. A single component heat curing epoxy adhesive can be impregnated into a synthetic polyester veil material creating a composite film in sheet form (hereinafter referred to in this specification as “pre-preg film”) that can be stored on a spool with separator release paper to keep it from sticking to itself prior to application. The spool of pre-preg film can then be preferably slit into narrow tape widths for wrapping onto the steel sucker rod although other means of applying the film can be utilized.

In some embodiments, composite pre-preg film stock made with single component heat curing epoxy and slit tapes can be stored in a freezer at 0 degrees Fahrenheit until applied to the sucker rod. In other embodiments, composite pre-preg film stock made with two component epoxy adhesive or other polymers must be made and used prior to the adhesive starting to polymerize.

In some embodiments, the steel sucker rod can be prepared for coating by first dry grit blast cleaning the steel. In some embodiments, a surface profile of 37-50 microns (1-2 Mils) can be created on the steel sucker rod to maximize adhesion with the composite coating.

In some embodiments, the composite pre-preg tape can be helically wrapped onto the steel sucker rod from one end to the other and up over the “upset bead” area. Optionally, the wrench square area and pin shoulder on the ends of the sucker rod can also be covered with the composite pre-preg tape. The paper separator ply between the layers of pre-preg tape on the spool is removed as the pre-preg tape is wrapped.

In some embodiments, the thermosetting composite pre-preg tape can then be cured in an oven. As the tape and steel sucker rod is heated, the single component epoxy can flow into the rough surface profile of the grit blasted steel, and can then subsequently cure. The result can be a synthetic fiber/epoxy composite coating over the steel sucker rod that can be well adhered to the sucker rod. The synthetic fiber reinforced epoxy coating can be less susceptible to damage and chipping off than resin-only coatings. The inherent toughness and adhesion of a fiber reinforced polymer composite coating is even more critical for continuous steel sucker rods since they are coiled on large spools, and the coils rub together in transport and deployment

Broadly stated, in some embodiments, a composite material protective corrosion barrier coating can be provided for one or more of steel sucker rods, steel pony rods, continuous steel sucker rods and pin ends, the coating comprising a veil material pre-impregnated with a thermosetting polymer adhesive.

Broadly stated, in some embodiments, a method can be provided for applying a corrosion barrier coating, the method comprising the steps of: wrapping veil material around one or more of a steel sucker rod, a pony rod, a continuous length of steel sucker rod and a sucker rod pin end, the veil material pre-impregnated with a thermosetting polymer adhesive; and curing the adhesive.

Broadly stated, in some embodiments, the method can further comprise the steps of cutting the veil material into lengths of tape strips, and helically wrapping the tape.

Broadly stated, in some embodiments, the step of curing the adhesive can comprise heating one or more of the steel sucker rod, the pony rod, the continuous length of steel sucker rod and the sucker rod pin end.

Broadly stated, in some embodiments, the step of heating can comprise induction heating the one or more of the steel sucker rod, the pony rod, the continuous length of steel sucker rod and the sucker rod pin end.

Broadly stated, in some embodiments, the method can further comprise wrapping additional layers of veil material around one or more of the steel sucker rod, the pony rod, the continuous length of steel sucker rod and the sucker rod pin end.

Broadly stated, in some embodiments, the veil material can comprise synthetic fibers.

Broadly stated, in some embodiments, the veil material can comprise one or more of a group comprising polyester, fiberglass in mat form, fiberglass in woven form, mat material made with aramid fiber, and combinations thereof.

Broadly stated, in some embodiments, the adhesive can comprise an epoxy adhesive.

Broadly stated, in some embodiments, the epoxy adhesive can comprise a single component epoxy adhesive.

Broadly stated, in some embodiments, the epoxy adhesive can comprise a two component epoxy adhesive.

### DESCRIPTION OF DRAWINGS

FIG. 1 is a block diagram depicting a method for coating a steel sucker rod.

FIG. 2 is a perspective view depicting a film coating being wrapped onto a steel sucker rod.

FIG. 3 is a perspective view depicting film-wrapped wrench flat and upset end of the steel sucker rod of FIG. 2.

FIG. 4 is a perspective view depicting the steel sucker rod of FIG. 2 after being wrapped and heat-cured.

FIG. 5 is a perspective view depicting a coated steel sucker rod with the coating worn off along the length thereof.

FIG. 6 is a perspective view depicting the coated steel sucker rod of FIG. 5.

FIG. 7 is a perspective view depicting the coated steel sucker rod of FIG. 5 after the worn coating has been repaired.

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

In some embodiments, a composite coated sucker rod can be provided, comprised of a synthetic matte or fabric like veil impregnated with polymer adhesive to create a conformable film or tape that is preferably helically wrapped onto the sucker rod body and cured in place as a protective corrosion barrier layer for the steel sucker rod.

In some embodiments, a variety of commercially available synthetic matte or fabric like veil materials can be impregnated with a polymer adhesive to be wrapped and cured on the steel sucker rod as a protective corrosion barrier. Polyester veils are one suitable example because of their resistance to water and chemicals along with their high elongation and toughness when impregnated with epoxy adhesive. Fiberglass in mat or woven form can also be used but can be more expensive than polyester. Other thin mat materials made with aramid fiber and combinations of various materials can also be suitable. For steel sucker rods, a composite pre-preg film thickness of approximately 6 mils can provide a sufficient barrier to the well fluids, adequate wear resistance and can be cost effective although much thicker veils can also be used if desired. A composite barrier coating made up of polyester veil and epoxy adhesive can have a higher elongation, and can be less brittle than unreinforced epoxy resin coatings. Additionally, the pre-preg composite coating can be more damage resistant than pure epoxy resin coatings. Furthermore, the inclusion of synthetic fibers in the polymer can increase the wear resistance of the coating if the sucker rod does contact the well bore tubing.

In some embodiments, the synthetic veil material can be impregnated with an epoxy adhesive. While there are a variety of thermosetting polymer resins available in the marketplace, single component epoxy adhesives can have excellent adhesion to substrates, and can be, typically, less brittle and more durable than two component epoxy resins. In some embodiments, a single component heat curing epoxy adhesive can be impregnated into the polyester veil at a resin volumetric ratio 50% or more to achieve a resin rich composite pre-preg material. The single component epoxy adhesive can have the base resin and hardener components pre-mixed together prior to impregnating the polyester veil. The hardener component can be latent when cold, and can be activated with heat to cause polymerization. The single component epoxy adhesive can have a long shelf life when stored at low temperatures, for example at 0 degrees Fahrenheit (−18° Celcius). For the purposes of this specification and the claims herein, the term “single component epoxy adhesive” refers to adhesives that comprise a base resin that is pre-mixed with a hardener, wherein the hardener is latent or inactive at lower temperatures (approximately, 0° Fahrenheit or −18° Celcius), until the pre-mixed adhesive is subjected to an elevated temperature (as determined by the manufacturer of the adhesive), whereas the adhesive approaches its glass transition temperature, “Tg” (as determined by the manufacturer of the adhesive) and, thus, become polymerized or “cured”. Examples of suitable single component epoxy adhesives include FM® 300 Epoxy Film Adhesive as manufactured by Cytec Industries Inc. of Tempe, Ariz., USA; Redux® 308 Modified epoxy film adhesive as manufactured by Hexcel Corporation of Stamford, Conn., USA; and Scotch-Weld™ Structural Adhesive Film AF 163-2 as manufactured by the 3M Company of St. Paul, Minn., USA. Since the hardener can be initially latent during the early stages of oven cure, the epoxy adhesive can drop in viscosity and, thus, flow into the surface profile of the grit blasted sucker rod. The epoxy adhesive can then cure when subjected to elevated temperatures, such as 250° Fahrenheit (121° Celcius), for a time period of approximately 2 hours. When cured, the polyester/epoxy laminate can become a composite material encasing the sucker rod, in contrast to a pure resin coating.

In some embodiments, two component epoxy adhesives can be used when or where epoxy adhesive or other polymers can be made and used prior to the adhesive starting to polymerize. For the purposes of this specification and the claims herein, the term “two component epoxy adhesive” refers to adhesives where the hardener is not mixed with the base resin until the mixed adhesive is required. Some two component epoxy adhesives can begin polymerizing or curing in as little as 5 minutes, whereas other types can take as long as 24 hours to begin polymerization at room temperature but will polymerize rapidly when exposed to heat. Two component epoxy adhesives can be used when a user wishes to make their own pre-preg film prior to applying it to steel sucker rods, as opposed to using pre-preg film manufactured with single component epoxy adhesive that must be stored in cooling facilities prior to use. Examples of suitable two component epoxy adhesives include 309 High Temp Industrial Epoxy as manufactured by Fibre Glast Developments Corporation of Brookville, Ohio, USA; PT2846 High Temperature Epoxy Laminating Resin as manufactured by PTM&W Industries, Inc. of Santa Fe Springs, Calif., USA; and TC-1607 A/B High Temperature Epoxy Laminating Resin as manufactured by BJB Enterprises, Inc. of Tustin, Calif., USA.

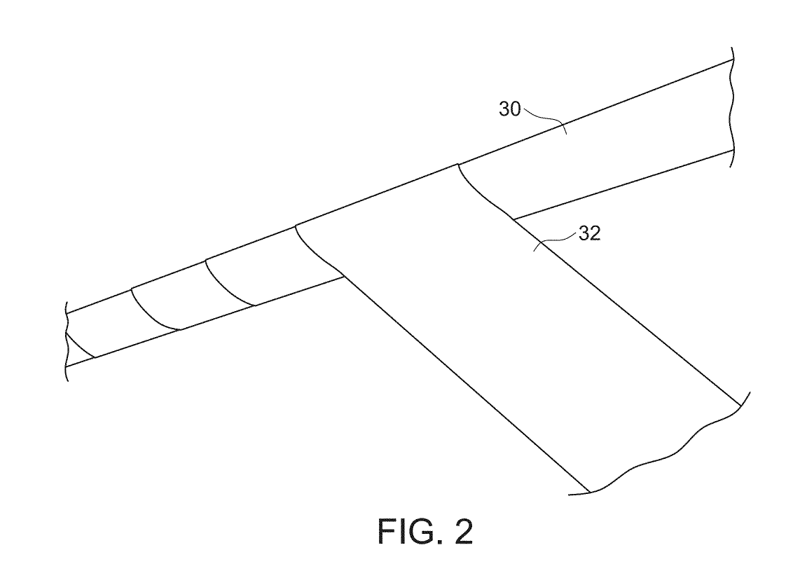

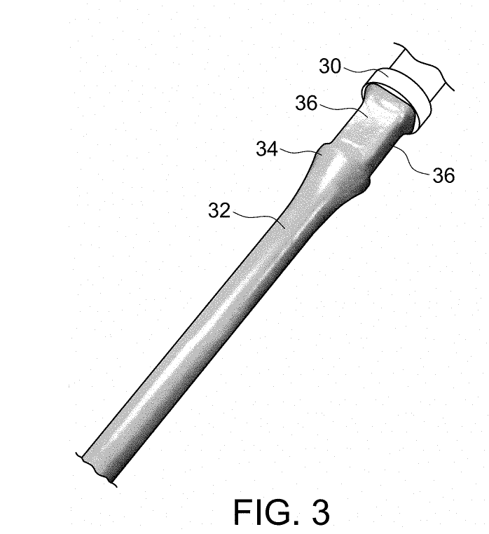

In some embodiments, the polyester/epoxy adhesive pre-preg tape can be helically wrapped along the sucker rod body. The band width of the wrap can be determined by the diameter of the rod, and the desired wrap angle. The band width to wrap, without gaps, can be: π×diameter of the rod×cosine of the desired angle for a single helical circuit. In some embodiments, the wrap can provide an overlap that is at least 3 times the material thickness to make an uninterrupted corrosion coating so this additional width can be added to the calculated bandwidth that the pre-preg film adhesive is cut to. In some embodiments, one feature of this process is the elimination of material waste by wrapping the protective coating on the sucker rod, in contrast to spraying a coating on a steel sucker rod. The polyester/epoxy pre-preg tape can either be hand wrapped on the steel sucker rod, or machine tape-wrapped, as shown in FIG. 2. Tension can be maintained on pre-preg film wrap 32 as it is applied to make the pre-preg film tight on steel sucker rod 30. Since pre-preg film wrap 32 can be somewhat stretchy prior to cure, it can conform to any irregularities on steel sucker rod 30, and can be wrapped up over elevator lift “upset” 34 and wrench flat areas 36 on the ends of steel sucker rod 30, as shown in FIG. 3. An additional layer of adhesive film can be applied to correct any “mistakes” in the wrapping process, or to increase the coating thickness in a given area without material waste. Other means to laminate the composite pre-preg over the steel sucker rod can be utilized, although helical wrapping is a method that can be automated easily.

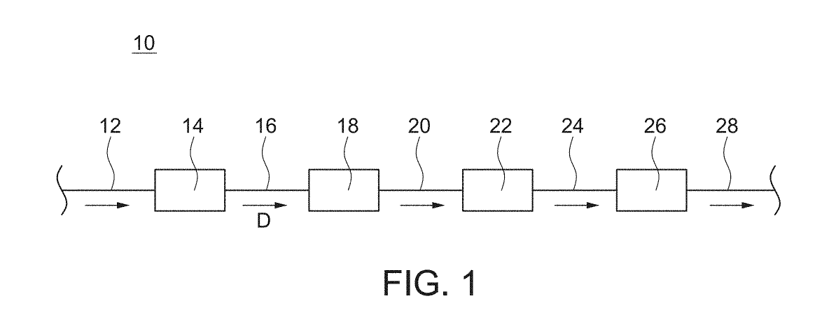

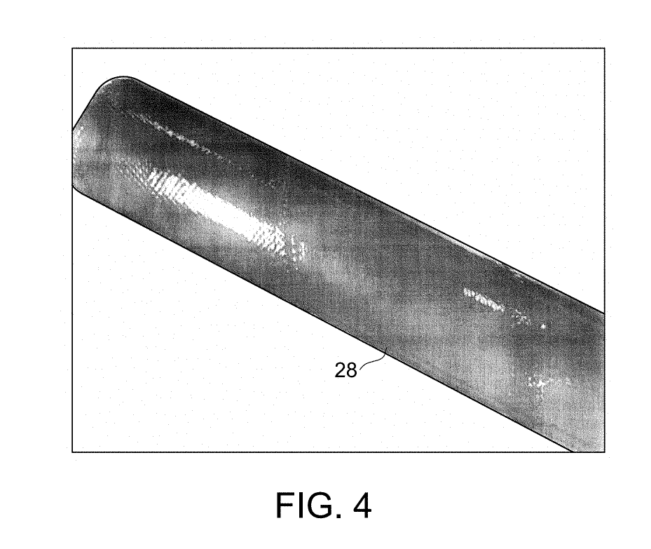

In some embodiments, the polyester/epoxy pre-preg tape can be machine-wrapped on a continuous length of steel sucker rod. Continuous sucker rods can be, typically, 1,500 to 8,000+feet (457 to 2438+metres) long, and can be manufactured in a continuous process line, as illustrated and labelled with reference numeral 10 in FIG. 1. In some embodiments, continuous sucker rod 12 can be grit blasted for surface preparation at grit blasting station 14 as surface-prepped rod 16 continuously moves through its manufacturing process. At cleaning station 18, any dust on rod 16 as a result of being grit-blasted can be removed by compressed air, washing with a solvent or both to produced cleaned rod 20. At film-wrapping station 22, pre-preg film can be helically wrapped or convolutely folded onto rod 20 just after the grit blast zone as rod 20 moves through the process line. After the pre-preg film is wrapped or applied on the continuous steel rod to produced wrapped rod 24, it can be cured as it passes through curing station 26 to produced cured wrapped rod 28. An example of a film-wrapped and cured steel sucker rod 28 is shown in FIG. 4. In some embodiments, the curing process can comprise induction heating the steel rod. Since a typical continuous rod line can run at high linear speeds, 10 to 20 ft per minute (3.05 to 6.10 metres per minute), oven curing the pre-preg film coating is not an effective method of curing because of the time required for the steel to heat up. Induction heating, on the other hand, can rapidly heat the steel rod which can then cure the pre-preg film. In some embodiments, the polyester/epoxy adhesive pre-preg film can be a dielectric so it is not heated by the induction heating process. The polyester/epoxy adhesive pre-preg film can, however, be conductively heated by the hot inductively-heated steel rod it is wrapped on. In some embodiments, multiple induction heating stations can be used to heat the rod to maintain the thru-put speed of the rod as it moves through its manufacturing process. In some embodiments, the mass of the steel rod can hold the heat between induction heating stations to allow the pre-preg composite to cure on the rod. In some embodiments, the formulation of the polymer used in the composite pre-preg film can be an important consideration for continuous sucker rod as the polymer must be cured before the continuous rod can be coiled.

In some embodiments, when the composite pre-preg film is helical wrapped on the steel rod, tension can be applied to the pre-preg film, in a representative embodiment, on the order of 2 lbs. although other tensions can be used. In some embodiments, the pre-preg film can be helically wrapped on steel rod that has been heated to 120° F.+/−10° F. The combination of a pre-heated rod and wrapping tension can reduce the potential of air becoming entrapped between the rod and the composite pre-preg film.

In other embodiments, a helical wrap of nylon peel ply can be over-wrapped on top of the composite pre-preg film to consolidate the pre-preg film to the steel rod and reduce the potential of air becoming entrapped between the rod and the composite pre-preg film. The stretchy nylon peel ply is also applied with tension so that it consolidates the composite pre-preg film on the steel rod. The nylon peel ply is removed after curing the composite pre-preg film. An example of a suitable nylon peel ply is Nylon Release Peel Ply as manufactured by Fibre Glast Developments Corporation of Brookville, Ohio, USA.

In other embodiments, a heat shrink film tape can be helical wrapped over the composite pre-preg film to help consolidate the composite pre-preg film during cure. When the composite pre-preg film is heat cured, the film tape shrinks further consolidating the composite pre-preg to the steel rod. An example of a suitable heat shrink film tape is 202 Series Heat Shrink Film Tape as manufactured by Von Roll Group of Breitenbach, Switzerland or 20% Shrink Tape as manufactured by Fibre Glast Developments Corporation of Brookville, Ohio, USA.

In other embodiments, a temporary vacuum bag can be applied over the steel rod after helical wrapping the composite pre-preg film for oven cure. One atmosphere vacuum applied to the bag positively eliminates the possibility of entrapped air between the steel rod and the composite pre-preg. Common vacuum bag materials and process are suitable, as well known to those skilled in the art.

In some embodiments, the surface profile and cleanliness of the grit blasted steel can be important to attain the best adhesion of the coating. In some embodiments, the surface profile can be rough, meaning, having a surface grit in the range of 37-50 Microns, or 1-2 mils, which can typically be obtained with aluminum oxide #100 grit abrasives and dry 120 psi high-pressure blasting. The grit blasted steel rod can be solvent washed if desired but is not necessarily required due to the excellent adhesion characteristics of the epoxy adhesive. In some embodiments, any remaining dust can be removed from the prepared rod without water or oil contamination. In some embodiments, the composite pre-preg film can be applied as soon as possible over the prepared sucker rod to avoid atmospheric oxidation of the prepared surface.

In some embodiments, the pre-preg film can be cured in an oven. It has been found that the sucker rod does not need to be rotated during the oven cure of the pre-preg film. The synthetic veil can support the epoxy adhesive as it heats up and can prevent the epoxy from running and dripping off the steel sucker rod during the cure. In some embodiments, a typical epoxy adhesive cure can be at 250 Fahrenheit (121.1° Celcius) for 1.5-2 hours for oven curing standard sucker rods. In other embodiments, a standard steel sucker rod can be induction heated to cure the pre-preg tape, which can cut down heat up time for the steel. Since the steel rod has significant mass and holds heat well, in some embodiments, a single induction coil can be mechanically reciprocated back and forth along the length of the sucker rod, or the sucker rod reciprocated through the induction coil, until the pre-preg film is cured in lieu of a convection oven.

While steel sucker rods are typically 25 feet or 30 feet (7.62 metres or 9.14 metres) in length, they can come in a variety of diameters including, but not limited to, ⅝ inch (15.9 mm), ¾ inch (19 mm), ⅞ inch (22.2 mm), 1 inch (25.4 mm) and 1⅛ inch (28.6 mm). The smaller diameter steel sucker rods are more flexible than the larger diameter sucker rods so the mid-section of these rods tend to be more subject to wear or rod slap in the well tubing during operation. To address this potential issue, additional layers of the composite pre-preg tape can be applied in the mid-span of the steel sucker rod to create more material thickness and greater wear resistance. The additional layers can be applied and co-cured with the base layer. Conventional Rod Guides can be over-molded on the composite pre-preg coating to reduce wear or for other purposes including wax removal in the case of rod pumping systems.

In some embodiments, the composite pre-preg coating can be applied to short length Pony Rods which can range from 1 feet to 12 feet (0.3 to 3.66 metres) in length, and which can be used to adjust the length of the sucker rod string. The method for composite pre-preg preparation, application and curing can be the same for Pony Rods as for full length steel sucker rods.

In some embodiments, the composite pre-preg coating can be applied to the connection ends of continuous sucker rods. This can be beneficial for High Density Polyethylene (“HDPE”) jacketed continuous steel sucker rods because the HDPE jacket stops before the connection ends, leaving that area susceptible to corrosion unless protected.

If a mistake is made in wrapping the composite pre-preg tape on the steel sucker rod leaving a bare spot of exposed steel, the mistake can be easily corrected by laying a patch of pre-preg film over the area and co-curing it with the base layer.

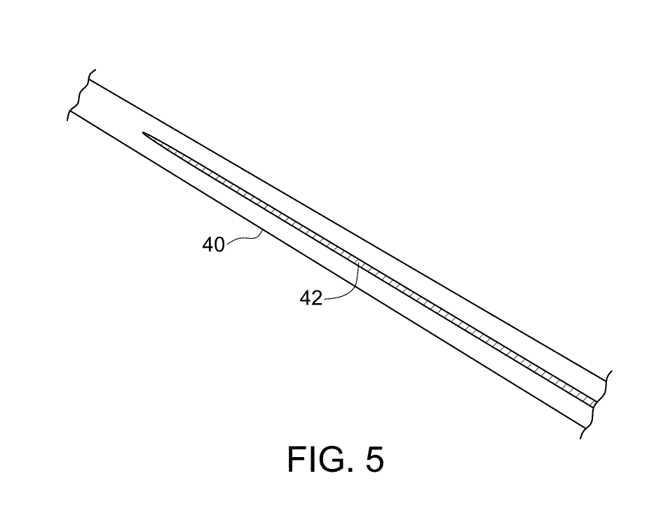

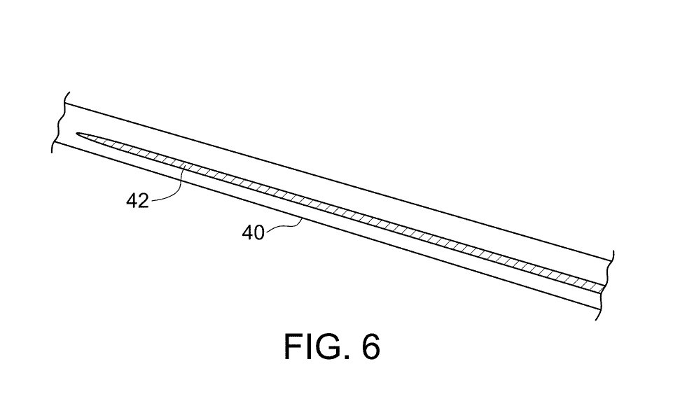

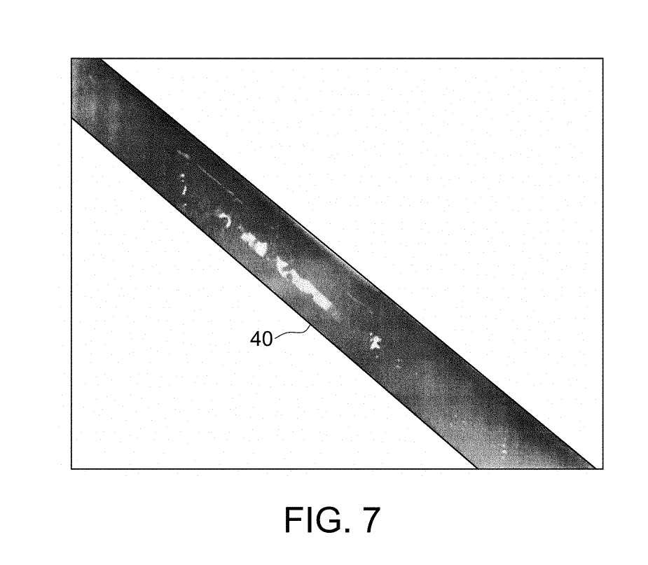

If the composite pre-preg film coating is damaged in field handling or by functional use, it is possible to repair the damage. Referring to FIGS. 5 and 6, shown is an example of a coated steel sucker rod 40 where the coating has been worn off along one longitudinal worn strip 42 on coated steel sucker rod 40. Repair can be accomplished by first cleaning the damaged area of the rod and sanding the damaged area smooth. Then, a new layer of composite pre-preg tape can be helically wrapped over the damaged area, and then heat cured in place. FIG. 7 shows rod 40 of FIGS. 5 and 6 after being repaired in this manner.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

What is claimed is:

1. A composite material protective corrosion barrier coating for at least one of a steel sucker rod, steel pony rod, a continuous steel sucker rod, or a pin end, the coating comprising a veil material pre-impregnated with a thermosetting polymer adhesive.

2. The barrier coating as set forth in claim 1, wherein the veil material comprises a synthetic fiber.

3. The barrier coating as set forth in claim 2, wherein the veil material comprises a member of a group comprising polyester, fiberglass in mat form, fiberglass in woven form, mat material made with aramid fiber, a combination thereof.

4. The barrier coating as set forth in claim 1, wherein the adhesive comprises an epoxy adhesive.

5. The barrier coating as set forth in claim 4, wherein the epoxy adhesive comprises a single component epoxy adhesive.

6. The barrier coating as set forth in claim 4, wherein the epoxy adhesive comprises a two component epoxy adhesive.

7. A method of applying a corrosion barrier coating, the method comprising:
a) wrapping veil material around at least one of a steel sucker rod, a pony rod, a continuous length of steel sucker rod, or a sucker rod pin end, the veil material pre-impregnated with a thermosetting polymer adhesive; and
b) curing the adhesive.

8. The method as set forth in claim 7, further comprising cutting the veil material into lengths of tape strips, and helically wrapping the tape.

9. The method as set forth in claim 7, wherein curing the adhesive comprises heating the at least one of the steel sucker rod, the pony rod, the continuous length of steel sucker rod, or the sucker rod pin end.

10. The method as set forth in claim 9, wherein the heating comprises induction heating the at least one of the steel sucker rod, the pony rod, the continuous length of steel sucker rod, or the sucker rod pin end.

11. The method as set forth in claim 7, further comprising wrapping additional layers of veil material around the at least one of the steel sucker rod, the pony rod, the continuous length of steel sucker rod, or the sucker rod pin end.

12. The method as set forth in claim 7, wherein the veil material comprises synthetic fibers.

13. The method as set forth in claim 12, wherein the veil material comprises a member of a group comprising polyester, fiberglass in mat form, fiberglass in woven form, mat material made with aramid fiber, and a combination thereof.

14. The method as set forth in claim 7, wherein the adhesive comprises an epoxy adhesive.

15. The method as set forth in claim 14, wherein the epoxy adhesive comprises a single component epoxy adhesive.

16. The method as set forth in claim 14, wherein the epoxy adhesives comprises a two component epoxy adhesive.

17. The method as set forth in claim 7, wherein the at least one of the steel sucker rod, the pony rod, the continuous length of steel sucker rod, or the sucker rod pin end comprises a previously-applied corrosion barrier coating, and wherein the previously-applied coating has been worn off at least a portion of the at least one of the steel sucker rod, the pony rod, the continuous length of steel sucker rod, or the sucker rod pin end.
